(19) United States
(12) Patent Application Publication
(10) Pub. No.: US 2006/0255071 A1
(43) Pub. Date: Nov. 16, 2006

(54) Fluid production distribution body and fluid product distributor comprising such a body

(76) Inventors: Alain Behar, Suresnes (FR); Laurent Decottignies, Cergy (FR)

Correspondence Address: SUGHRUE MION, PLLC, 2100 PENNSYLVANIA AVENUE, N.W., SUITE 800, WASHINGTON, DC, 20037, US

(21) Appl. No.: 10/548,656

(22) PCT Filed: Mar. 11, 2004
(86) PCT No.: PCT/FR04/00580

§ 371 Date: Jul. 10, 2006

(30) Foreign Application Priority Data
Mar. 13, 2003 (FR) 03/03134

(51) Int. Cl. G01F 11/00

(52) U.S. Cl. 222/256

(57) ABSTRACT

The invention relates to a fluid product distribution body (1), comprising a fluid product distribution chamber (10) with a variable volume defined with an inlet valve (15, 115), by means of which the chamber (10) communicates with the reservoir (20), said valve comprising a seat (115) and a moving body (15), a piston (135) which may be displaced to vary the volume of the chamber (10), said piston (135) being held in the rest position by means of a return spring (131) and an outlet valve (131, 125), by means of which the fluid product escapes from the chamber (10), under pressure, to flow towards a distribution opening (127). Said valve comprises a valve seat (125) and a moving valve body (131) which may be displaced with a sealing effect when not in contact with said seat, the return spring means and the mobile valve body being formed by one and the same element (131) comprising a wall (130) in sealing contact with the seat (125), the seat (125) having an annular embodiment. The invention is characterised in that the element (131) runs in a sealing manner within the seat.

This present invention relates to a device for the dispensing of a fluid product, intended to be mounted on a fluid-product reservoir in order to draw off the said fluid product. The invention also concerns a fluid-product dispenser that is essentially composed of such a dispensing device, and its associated fluid-product reservoir. This type of dispensing device is frequently used in the areas of perfumery, cosmetics or indeed in pharmacy, in order to act as rapid-action, manually-operated or repeating dispenser of a fluid product.

In general, the dispensing device is a pump or a valve that includes a fluid-product dispensing chamber of variable volume. The chamber conventionally includes an intake valve by which the chamber communicates with the reservoir. The chamber also includes a piston, which can be displaced by pressing on a push-rod in order to vary the volume of the chamber and thus put the fluid product contained in the chamber under pressure. The piston is generally held in its rest position by means of a return spring. In addition, an outlet valve allows the fluid product under pressure to exit from the chamber in order to flow to a dispensing orifice. Like any valve, the outlet valve includes a valve seat and a movable valve device capable of moving so as to make sealed contact with its seat. When the pressure is sufficiently high in the chamber, the movable device lifts off its seat thereby clearing an exit passage for the fluid product under pressure. The above constitutes a design that is quite conventional for a pump.

One is already familiar, from previous designs, with dispensing devices of the pump type using a part made of an elastic material to form the intake valve, the return spring and the outlet valve. More precisely, the part made of an elastic material forms the movable devices of the intake and exit valves intended to selectively come into sealed contact with their respective seats. One could mention document FR-2 674 024, for example. In this document, a part made of an elastic material includes a central part, a peripheral part and a stretchable elastic junction part connecting the central part to the peripheral part. The central part rests on a bushing forming an intake opening. The central part forms a sort of elastically-deformable tongue which rests selectively in a sealed manner on the intake opening. The tongue and the hole together form the intake valve. The junction part acts as a return spring. The peripheral part is in engaged with a push-rod which forms an exit conduit. The peripheral part also forms a peripheral lip which presses against another peripheral part of the push-rod. The peripheral lip forms the movable device of the outlet valve. In the pump described in this document concerning a previous design, each part of the elastically deformable part has a particular function, namely that of intake valve for the central part, a return spring for the linking part and the outlet valve for the peripheral part.

The aim of this present invention is to specify a dispensing device whose functional dispensing action is different. Another aim of the invention is to create a dispensing device whose dispensing orifice is fixed, meaning that it is independent of the movement of the actuating push-rod.

In order to achieve these aims, this present invention is proposing a device for the dispensing of a fluid product, intended to be mounted on a fluid-product reservoir in order to draw off the fluid product, the said dispensing device including a fluid-product dispensing chamber of variable volume, the said chamber including an intake valve by which the chamber is intended to be put in fluid communication with the reservoir, the said valve including a seat and a movable device, a piston which can be displaced by pressing on a push-rod in order to vary the volume of the chamber and thus put the fluid product contained in the chamber under pressure, the said piston being held in its rest position through return spring means, and an outlet valve by which the fluid product under pressure exits from the chamber in order to flow to a dispensing orifice, the said valve including a valve seat and a movable valve device capable of moving into and out of sealed contact with the said seat, characterised in that the return spring and the movable device of the outlet valve are formed by one and the same element. Advantageously, the element is deformable by elastic extension. In addition, the seat of the outlet valve may be fixed in relation to the seat of the intake valve. Additionally or as a variant, the seat of the outlet valve may be movable in relation to the push-rod. The result is thus a dispensing device with a fixed dispensing orifice including an element in which the same zone forms both the return spring and the movable device of the outlet valve. This deformation is obtained by stretching or elongation. On can also envisage deformation by bending or compression.

Advantageously, the element includes a wall that is in sealed contact with the seat, the said wall sliding in a sealed manner on the seat.

According to another characteristic of the invention, the element includes one fixed end attached to anchoring means and one movable end, the piston being attached to the movable end. Advantageously, the piston and the element are created as a single block piece.

According to one advantageous form of implementation, the seat is annular, with the element sliding in a sealed manner on the inside of the seat.

According to one practical form of implementation, the element is formed from a sleeve which is elastically stretchable, more or less cylindrical, and elastically deformable on the inside. Advantageously, the sleeve includes an outer wall designed to make sliding sealed contact with a peripheral annular seat which surrounds the sleeve. Preferably, the sleeve is formed as a single block piece which also forms the piston and the anchoring means. Advantageously, the sleeve comes into contact, pressing with increasing force on the seat as it is increasingly stretched. The sleeve can take the form of a section of tube that is more or less cylindrical or tapered, whose outer wall comes into contact with an external peripheral annular seat.

This present invention also concerns a fluid-product dispenser that includes a fluid-product reservoir and a dispensing device as specified above.

The invention will now be described in greater detail with reference to the attached drawings, which are provided by way of a non-limited example of one method of implementing the invention.

In the figures:

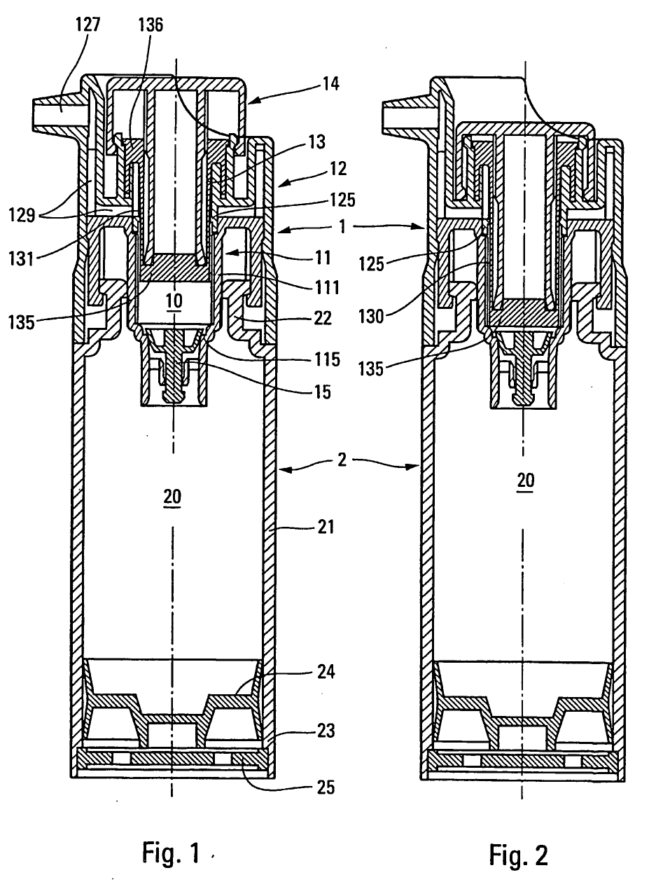

FIG. 1 is a view in vertical transverse section through a fluid-product dispenser equipped with a device for the dispensing of a fluid product according to the invention, in its rest position

FIG. 2 is a view similar to that of FIG. 1 in the actuated position, and

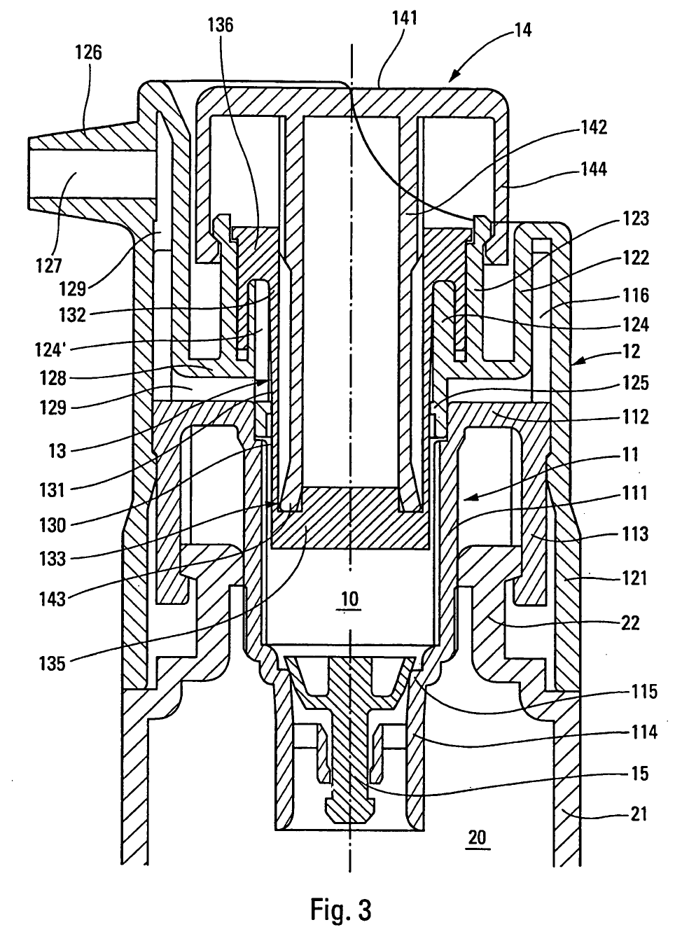

FIG. 3 is an enlarged view of the dispensing device of FIG. 1.

In the implementation example used to explain this present invention and shown in FIGS. 1 to 3, the dispensing device is a pump. However, the spirit of the invention to be described below can also be applied to a valve.

The fluid-product dispenser which incorporates the dispensing device of the invention essentially consists of a receptacle 2 associated with the said dispensing device of the invention.

The receptacle 2 consists of a reservoir barrel 21 which is created over the major part of its height with a transverse section that is more or less cylindrical but not necessarily circular. The inside of the barrel 21 forms a sealed sliding wall. A wiper or follower piston 24 is placed on the inside of the barrel 21, and this piston 24 is intended to move with a sealed sliding contact against the inner wall of the barrel 21. The barrel 21 and the follower piston 24 together comprise a fluid-product reservoir 20. Here, this reservoir is of variable volume, given that the piston 24 will move in the barrel 21 so as to reduce the effective volume of the reservoir 20. Generally, the receptacle 2 includes a bottom end 23 and a top end forming a neck 22. The neck has an opening which is often of smaller section than that of the barrel 21. FIGS. 1 and 2 show the reservoir 20 with maximum volume. The piston 24 is then located close to the bottom end 23 of the barrel 21. Optionally, the bottom end 23 can be fitted with a bottom 25 advantageously pierced with one or more holes used to connect the space located between the piston 24 and the bottom 25 with the outside world. The fluid product occupies the space formed between the piston 24, the barrel 21, and the neck 22. As the fluid product is extracted from the reservoir 20, the piston 24 moves by suction toward the neck 22, thereby reducing the effective volume of the reservoir 20. This is a conventional piston system, frequently used for sensitive fluid products which can deteriorate in contact with the air. The advantages with this type of reservoir is indeed that the fluid product is never in contact with the outside air. However, the dispensing device according to the invention can be used with other types of reservoir, such as freely deformable flexible sachets or indeed the more conventional receptacles in the form of rigid bottles or flasks.

The dispensing device 1 according to the invention includes a body which here is created in two parts, namely a socket 11 and a cap 12. The body is made in two parts to make it easier to mould. In fact, it is not excluded that the body can be made as a single block piece. In addition to the body formed from the socket 11 and the cap 12, the dispensing device also includes a part made from an elastic material 13, a push-rod 14 and an intake valve movable device 15. It can thus be said that the dispensing device is made from five separate parts.

The socket 11 forms a chamber barrel 111 which here is of circular cylindrical shape, but which can be of different shapes, namely non-circular and even non-cylindrical. This chamber barrel 111 is extended downwards by an intake sleeve 114 which constitutes a passage for the entry of a fluid product. This sleeve 114 forms the seat of an intake valve 115. Inside, the sleeve 114 accommodates an intake valve movable device 15. This movable device 15, in association with the seat 115, together form the intake valve of the pump. In the figures, the movable device 15 is formed from a plastic part forming a corolla which makes a sealed contact on the seat 115. Shown here are particular forms of implementation which do not limit the scope of the application. In place of this plastic part 15, it is possible to use a metal ball, for example. More generally, the particular form of the intake valve is not critical to this present invention, and any intake valve can be used in the invention. The chamber barrel 111 is extended upwards by an annular bracket 112 which extend radially to the outside. This bracket 112 is then extended downwards by a securing ring 113. This securing ring 113 is intended to lock onto the neck 22. In the example shown in the figures, this is a click-on action, where the ring 113 forms a click-on or detent head designed to click onto a peripheral rim formed by the neck 22. Here again, this is only one particular form of implementation which has no limiting implications. In fact, other fixing means can be used in this present invention. The ring 113 does not even need to be made as a single block piece with the chamber barrel 111. Attachment by screwing or crimping can also be considered. The socket 11 also forms a fixing sleeve 116 which extends upwards as an extension to the ring 113. This fixing sleeve 116 can advantageously be formed only with angular sleeve sections so as to form slots. The fixing sleeve 116 is thus composed of several angular segments separated by slots. When the socket 11 is mounted on the neck 22, the chamber barrel 111 penetrates, at least partially, inside the opening of the neck 22. The intake sleeve 114 can be placed inside the reservoir 20. In this way, the fluid product stored in the reservoir 20 can penetrate into the inside of the socket through the sleeve 114 after opening of the intake valve, that is after raising the movable device 15 from its seat 115.

The cap 12 includes an external skirt 121 intended to lock onto the ring 113, advantageously by click-action. The skirt can rest against the receptacle 2. The skirt 121 surrounds the ring 113. The skirt 121 forms a dispensing ferrule 126 which forms a dispensing orifice 127. The skirt 121 also makes contact with the fixing sleeve 116. The cap 12 includes an internal bushing 122 which extends concentrically to the inside of the skirt 121. The bushing 122 and the skirt 121 are joined together at their top ends. Between them, the skirt 121 and the bushing 122 form an annular ring which forms a section of exit channel 129 which communicates with the dispensing orifice 127. The bushing 122 is extended downwards by a bottom bracket 128. The bottom bracket 128 supports a guidance bushing 123 which extends upwards. Still further inside, the bottom bracket 128 is connected to a support sleeve 124. This sleeve 124 extends upwards but also downwards in relation to the bottom bracket 128. The support sleeve 124 has at least one cut-out 124′ in the form of a longitudinal vertical slot. This slot 124′ extends to just below the bottom bracket 128. Beneath this slot 124′, the support sleeve 124 forms an annular bead 125 which extends radially inwards. This bead 125 forms a sort of protrusion from the inner wall of the support sleeve 124. The end of the support sleeve 124 locks onto the top end of the chamber barrel 111 formed by the socket 11. The contact between the support sleeve 124 and the socket 11 is preferably sealed. The bottom bracket 128 is spaced from the annular bracket 112 so as to form another section of the exit channel 129. This section 129 is connected directly to the dispensing orifice 127. It can be said that the support sleeve 124 more or less extends the chamber barrel 111 and provides a lateral exit through the slot 124 which then communicates by means of the exit channel 129 up to the ferrule 126 forming the dispensing orifice 127.

The part made of an elastic material 13 includes an anchor crown 136, an elastically stretchable sleeve 131 and a piston 135. The part made of an elastic material 13 is created as a single block piece. The anchor crown 136 locks onto the top part of the support sleeve 124. The crown 126 can former a lip which extends between the bushing 123 and the sleeve 124. The anchor crown 136 is thus attached to the cap 12. The sleeve 131 includes a top end 132 connected to the crown 136 and a bottom end 133 connected to the piston 135. Sleeve 131 extends into the inside of sleeve 124 and of the chamber barrel 111, and the piston 135 is located on the inside of the chamber barrel 111. Sleeve 131 has a characteristic of deformation by stretching so that its length or height can vary considerably. In addition, the sleeve also has inward and outward radial deformability characteristics. Put more simply, the sleeve can be compared to a section of elastically stretchable pipe of more or less cylindrical or tapered shape. In the case shown in the figures, the sleeve has a slightly tapered shape. In fact, the section of the sleeve at its top end 132 is slightly larger than that at its bottom end 133. The sleeve 131 and the piston 135 do not need to make sealed contact on the inside of the chamber barrel 111. In fact, a gap can exist between the piston and the barrel. Because sleeve 131 extends to the inside of support sleeve 124, its outer wall 130 has to make peripheral contact with the bead 125. According to the invention, this contact is sealed. Thus, the chamber barrel 111, the bottom part of the sleeve 124 which extend from the bead 125, the bottom part of the sleeve 131, the piston 135 and the movable device 15 of the intake valve, together form a dispensing chamber 10 of variable volume. The movement of the piston 135 in the barrel 111 by pulling to a variable degree on the sleeve 131 causes the internal volume of the dispensing chamber 10 to vary.

In order to enable movement of the piston 135, the dispensing device includes a push-rod 14 forming a bearing surface 141 edged with a retaining skirt 144 locked around the guidance bushing 123. The push-rod 14 also includes an actuating rod 142 which is locked onto the piston 135. It can be seen easily that by pressing on the bearing surface 141 of the push-rod 14, the rod 142 is forced into the sleeve resulting in movement of the piston 135 toward the intake valve. The sleeve then undergoes a deformation by elastic extension and its outer wall 130 slides in a sealed manner against the external peripheral bead 125. When the pressure on the inside of the dispensing chamber 10 exceeds a certain threshold, the sleeve, although already stretched elastically, will deform radially inwards lifting off the bead 125. This result in the clearance of an exit passage for the fluid product under pressure which can then flow through the slot 124′ and the exit channel 129 to reach the dispensing orifice 127. When the pressure drops below this threshold, the outer wall 130 of the sleeve returns into sealed contact against the bead 125. The bead 125 then performs the function of a seat of the outlet valve, and the outer wall of the sleeve performs the function of a movable device of the outlet valve, intended to come into selective sealed contact. It should be noted however that the contact of the outer wall 130 of the sleeve is a dynamic contact since it is sliding. In fact, at the beginning of the actuating phase, the piston 135 moves and stretches the sleeve 131. The outer wall 130 then moves in sealed contact on or inside the bead 125.

With the invention, one single element, namely the sleeve 131, defines, forms or is formed by a zone performing both the function of a return spring and a movable device of the outlet valve. In addition, the placement of the sleeve inside the seat results in the creation of a dispenser whose dispensing orifice is fixed in relation to the reservoir. In fact, the movement of the push-rod 14 is totally independent of the dispensing orifice. The seat of the outlet valve defines a relative choke point of the sleeve at which the imaginary straight line separating the top end and the bottom end of the sleeve is broken. In this way, the sealed contact of the outer wall 130 of the sleeve on the seating bead 125 takes place with steadily increasing pressure force as pressure is applied to the push-rod 14. In other words, the greater the pressure on the push-rod 14 the more the sleeve presses against the seat. The contact between the sleeve and the seat is broken however when the pressure reaches a sufficiently high value inside the dispensing chamber 10. This results in the creation of a sort of pre-compression force which hardens the operation of the dispenser. The sleeve 131 extends here in a more or less rectilinear or straight manner. Nevertheless, it is possible to imagine methods of implementation in which the seat of the outlet valve 125 forms a larger choke point, so that the sleeve can adopt X or Y shapes. The more the seat chokes the sleeve, the greater is the pressure threshold for opening the outlet valve.

A dispenser according to a form of implementation non shown here can include an element that is deformable by bending or compression which performs both the functions of spring and outlet valve in a single zone.

By means of the invention, a dispensing device is created from a small number of easily moulded parts, allowing manufacturing costs to be reduced.

1. A device for the dispensing of a fluid product (1) intended to be mounted on a fluid-product reservoir (20) in order to draw off the fluid product, where the said dispensing device includes a fluid-product dispensing chamber (10) of variable volume, and where the said chamber includes:
an intake valve (15, 115) by which the chamber (10) is intended to be put into fluid communication with the reservoir (20), where the said valve includes a seat (115) and a movable device (15),
a piston (135) that can be moved by pressing on a push-rod (14) in order to vary the volume of the chamber (10) and thus to put the fluid product contained in the chamber under pressure, where the said piston (135) is held in its rest position through return spring means (131), and
an outlet valve (131, 125) by which the fluid product under pressure exits from the chamber (10) in order to flow to a dispensing orifice (127), where the said valve includes a valve seat (125) and a movable valve device (131) capable of moving into and out of sealed contact with the said seat, where the return spring and the movable device of the outlet valve are formed from one single element (131) which is deformable by elastic extension, the element (131) including a wall (130) that is in sealed contact with the seat (125), the seat (125) being annular,
characterised in that the element (131) slides in a sealed manner inside the seat.

2. A dispensing device according to claim 1, in which the element is formed by a sleeve (131) which is elastically stretchable, more or less cylindrical and elastically deformable inwards.

3. A dispensing device according to claim 2, in which the sleeve (131) includes an outer wall (130) designed to make sliding sealed contact with a peripheral annular seat (125) surrounding the sleeve.

4. A dispensing device according to claim 2, in which the sleeve (131) is formed as a single block piece (13), also forming the piston (135) and anchoring means (136).

5. A dispensing device according to claim 2, in which the sleeve (131) comes into contact, pressing with increasing force on the seat (125) as it is increasingly stretched.

6. A dispensing device according to claim 1, in which the element (131) includes a fixed end (132) attached to anchoring means (136) and a movable end (133), where the piston (135) is attached to the movable end (133).

7. A dispensing device according to claim 6, in which the piston (135) and the element (131) are manufactured as a single block piece.

8. A device according to claim 1, in which the seat (125) of the outlet valve is fixed in relation to the seat (115) of the intake valve.

9. A device according to claim 1, in which the seat (125) of the outlet valve is movable in relation to the push-rod.

10. A device according to claim 1, in which the dispensing orifice is fixed in relation to the seat (115) of the intake valve and the reservoir.

11. A fluid-product dispenser including a fluid-product reservoir (20) and dispensing device (1) according to claim 1.
